(19) United States
(12) Patent Application Publication
(10) Pub. No.: US 2004/0064982 A1
(43) Pub. Date: Apr. 8, 2004

(54) Method and means for expressing special positive feelings

(76) Inventor: Larry A. Christensen, Thornton, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 10/668,832

(22) Filed: Sep. 23, 2003

Related U.S. Application Data
(60) Provisional application No. 60/416,906, filed on Oct. 8, 2002.

(51) Int. Cl. G09F 1/00; G09F 3/00

(52) U.S. Cl. 40/124.06; 40/312

(57) ABSTRACT

A method of creating an expression of a positive feeling such as love towards another involves taking an empty receptacle, such as a package, wrapping and enclosing the package with gift-style material, placing a note on the package expressing the positive feelings to the recipient of the package and including a request that the package remain unopened but suggesting that the unopened package is filled with the positive feelings. A closed wrapped container, such as a package, has a written note on an exterior surface thereof advising the recipient leave the package unopened, but suggesting that the unopened package is filled with the positive feelings such as love.

### CROSS REFERENCE TO A RELATED APPLICATION

This application is a continuation of Serial No. 60/416,906 filed Oct. 8, 2002.

### BACKGROUND OF THE INVENTION

Gift cards and the like are typically used to express special positive feelings to selected persons. While some such cards are saved by the recipient, and perhaps read over from time to time, the physical makeup of the card itself, aside from the verse inside or a picturesque cover, do not cause the recipient to even remember the donor without removing the card from its envelope.

It is therefore a principal object of this invention to provide a method and means for expressing special positive feelings.

A further object of the invention is to provide a method and means for expressing special positive feelings which will convey an aura of warmth and love to the recipient without opening the container with which the expression of love or other good feelings is delivered.

These and other objects will be apparent to those skilled in the art.

### SUMMARY OF THE INVENTION

A method of creating an expression of a positive feeling such as love towards another involves taking an empty receptacle, such as a package, wrapping and enclosing the package with gift-style material, placing a note on the package expressing the positive feelings to the recipient of the package and including a request that the package remain unopened but suggesting that the unopened package is filled with the positive feelings.

The apparatus of this invention is a closed wrapped container, such as a package, has a written note on an exterior surface thereof advising the recipient leave the package unopened, but suggesting that the unopened package is filled with the positive feelings such as love.

### DESCRIPTION OF THE DRAWINGS

FIG. 1 is a perspective view of a package embodying the instant invention; and

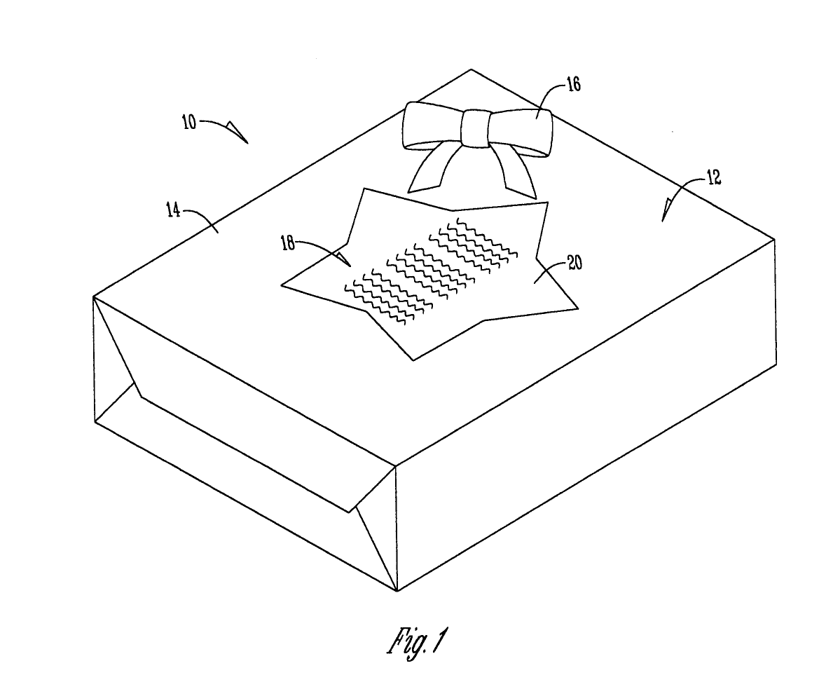

FIG. 2 is an enlarged scale perspective view of the front portion of the package of FIG. 1.

### DESCRIPTION OF THE PREFERRED EMBODIMENT

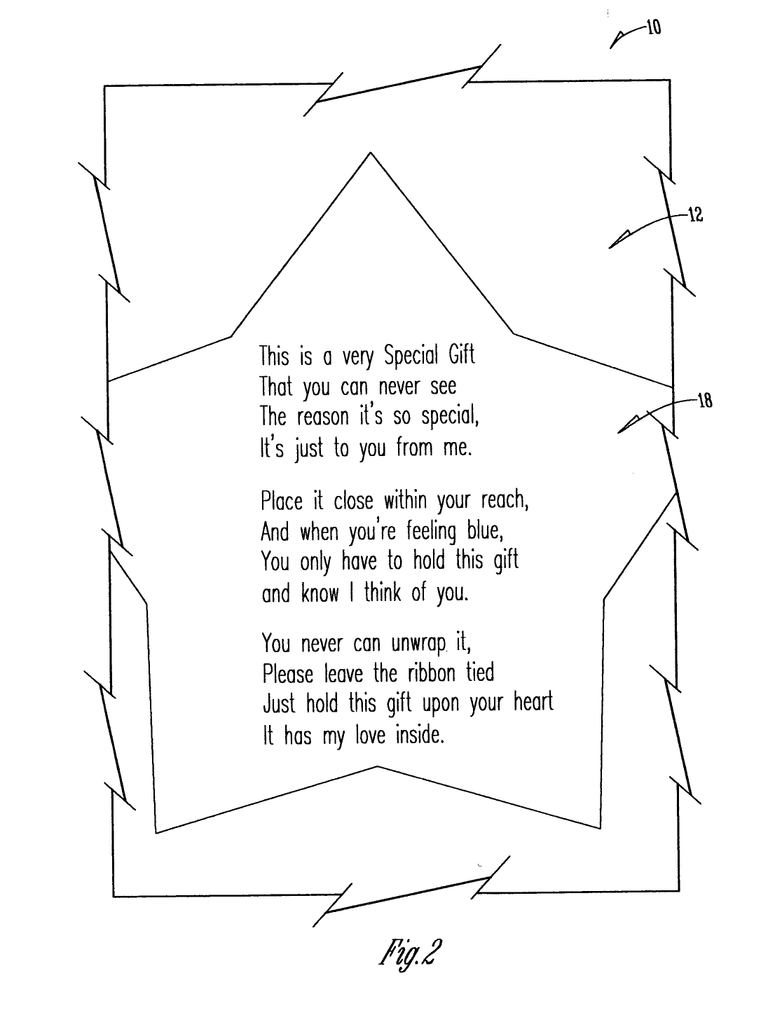

A closed box 10 or other suitable container such as a closed envelope is preferably wrapped in a gift style wrapping material 12 having an upper surface 14. Bows 16 or the like may also be used. Then, a suitable message 18, such as a poem, is placed on the package expressing the thoughts of special feelings to the recipient of the wrapped package. The message should also include a request that the package remain unopened. (FIG. 2) It should also suggest that the package is filled with the special feeling, such as love. Again, the message preferably should be a poem. Samples of preferred type messages appear below.

### EXAMPLE 1

This is a very Special Gift
That you can never see,
The reason it's so special
It's just for you from me.
Place it on your desk at work
And when you're feeling blue
You only have to hold this gift
And know I think of you.
You never can unwrap it,
Please leave the ribbon tied,
Just hold this gift upon your heart
It has my love inside.

### EXAMPLE 2

This is a very Special Gift
That you can never see,
The reason it's so special,
It's just to you from me.
Place it close within your reach,
And when you're feeling blue,
You only have to hold this gift
And know I think of you.
You never can unwrap it,
Please leave the ribbon tied,
Just hold this gift upon your heart
It has my love inside.

It is therefore seen that the recipient will always think of the donor whenever the package is in view, and will be filled with unexpressed thoughts of love and remembrance.

Accordingly, this invention will achieve its stated objectives.

I claim:

1. A method of creating an expression of a positive feeling such as love towards another involves taking an empty receptacle, such as a package,
placing a note on the package expressing the positive feelings to the recipient of the package and including a request that the package remain unopened but suggesting that the unopened package is filled with the positive feelings.

2. The method of claim 1 wherein the positive feelings are identified as being feelings of love.

3. The method of claim 1 wherein the note is a poem.

4. The method of claim 1 comprising an initial step of wrapping and enclosing the package with a gift-style material.

5. A closed container, comprising,
a message on the container expressing thoughts of special positive feelings, and including a request that the container not be opened and suggesting that the container is filled with the good feelings.

6. The device of claim 5 wherein the container is a closed package.

7. The device of claim 5 wherein the message is a poem.

8. The device of claim 5 wherein the container is a gift-style container.

9. The device of claim 8 wherein the container is covered with a special gift style paper.

10. The device of claim 5 wherein the container is an envelope.
